(19) United States
(12) Patent Application Publication
(10) Pub. No.: US 2026/0231045 A1
(43) Pub. Date: Aug. 6, 2026

(54) TECHNIQUES FOR DETERMINING POWER HEADROOM FOR SUB-BAND FULL-DUPLEX AWARE USER EQUIPMENT OPERATION

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Abdelrahman Mohamed Ahmed Mohamed IBRAHIM, San Diego, CA (US)

(21) Appl. No.: 19/044,460

(22) Filed: Feb. 3, 2025

(51) Int. Cl. H04W 52/14; H04L 5/14; H04W 52/36; H04W 76/20

(52) U.S. Cl. CPC H04W 52/146; H04L 5/14; H04W 52/365; H04W 76/20

(57) ABSTRACT

Various aspects of the present disclosure generally relate to wireless communication. In some aspects, a user equipment (UE) may receive configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation. The UE may transmit information identifying a set of power headroom (PHR) parameters for a serving cell, wherein the set of PHR parameters includes an SBFD PHR parameter and a non-SBFD PHR parameter for the serving cell. Numerous other aspects are described.

### FIELD OF THE DISCLOSURE

Aspects of the present disclosure generally relate to wireless communication and specifically relate to techniques, apparatuses, and methods associated with determining power headroom for sub-band full-duplex (SBFD) aware user equipment (UE) operation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A radio access network (RAN) may support communications between user equipments (UEs) and network nodes (such as gNBs, distributed units, radio units, or the like). Communications from a UE to a network node may be referred to as uplink communications, and communications from a network node to a UE may be referred to as downlink communications. Uplink communications may occur on an uplink, and downlink communications may occur on a downlink. The downlink, or a downlink communication on the downlink, may be referred to as having or being associated with one link direction (e.g., a first link direction). The uplink, or an uplink communication on the uplink, may be referred to as having or being associated with another link direction (e.g., a second link direction). As used herein, “first link direction” and “second link direction” refer to different link directions, and not necessarily to specific link directions. For example, as used herein, a first link direction may be one of the downlink or the uplink, and a second link direction may be the other of the downlink or the uplink.

Some UEs or network nodes may support communication in only one link direction at a given time, which is referred to as half-duplex communication. A UE that supports or is capable of only half-duplex communication may be referred to as a half-duplex UE. Other UEs or network nodes may support simultaneous communication in two or more link directions, which is referred to as full duplex communication. One type of full duplex communication is sub-band full duplex (SBFD) communication, in which a communication bandwidth of a UE or a network node is divided into one or more downlink sub-bands (or more generally, sub-bands having a first link direction) and one or more uplink sub-bands (or more generally, sub-bands having a second link direction different than the first link direction).

SBFD communication can be supported at a network node, a UE, or both. A UE that can interpret signaling relating to SBFD communication (such as signaling that configures particular sub-bands or particular time resources to be SBFD resources in which SBFD communication is supported), and that is not capable of performing and/or not configured to perform SBFD communication, may be referred to as an SBFD aware UE. A UE that can interpret signaling related to SBFD communication, and that is capable of performing or configured to perform SBFD communication, may be referred to as an SBFD capable UE.

### SUMMARY

Some aspects described herein relate to a method of wireless communication performed by a user equipment (UE). The method may include receiving configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation. The method may include transmitting information identifying a set of power headroom (PHR) parameters for a serving cell, wherein the set of PHR parameters includes an SBFD PHR parameter and a non-SBFD PHR parameter for the serving cell.

Some aspects described herein relate to a method of wireless communication performed by a network node. The method may include transmitting configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The method may include receiving information identifying a set of PHR parameters for a serving cell, wherein the set of PHR parameters includes an SBFD PHR parameter and a non-SBFD PHR parameter for the serving cell.

Some aspects described herein relate to a UE. The UE may include a processing system. The processing system may include one or more processors and one or more code-storing memories coupled with the one or more processors. The processing system may be configured to cause the UE to receive configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The processing system may be configured to cause the UE to transmit information identifying a set of PHR parameters for a serving cell, wherein the set of PHR parameters includes an SBFD PHR parameter and a non-SBFD PHR parameter for the serving cell.

Some aspects described herein relate to a network node. The network node may include a processing system. The processing system may include one or more processors and one or more code-storing memories coupled with the one or more processors. The processing system may be configured to cause the network node to transmit configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The processing system may be configured to cause the network node to receive information identifying a set of PHR parameters for a serving cell, wherein the set of PHR parameters includes an SBFD PHR parameter and a non-SBFD PHR parameter for the serving cell.

Some aspects described herein relate to a non-transitory computer-readable medium that stores a set of instructions for wireless communication by a UE. The set of instructions, when executed by one or more processors of the UE, may cause the UE to receive configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The set of instructions, when executed by one or more processors of the UE, may cause the UE to transmit information identifying a set of PHR parameters for a serving cell, wherein the set of PHR parameters includes an SBFD PHR parameter and a non-SBFD PHR parameter for the serving cell.

Some aspects described herein relate to a non-transitory computer-readable medium that stores a set of instructions for wireless communication by a network node. The set of instructions, when executed by one or more processors of the network node, may cause the network node to transmit configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The set of instructions, when executed by one or more processors of the network node, may cause the network node to receive information identifying a set of PHR parameters for a serving cell, wherein the set of PHR parameters includes an SBFD PHR parameter and a non-SBFD PHR parameter for the serving cell.

Some aspects described herein relate to an apparatus for wireless communication. The apparatus may include means for receiving configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The apparatus may include means for transmitting information identifying a set of PHR parameters for a serving cell, wherein the set of PHR parameters includes an SBFD PHR parameter and a non-SBFD PHR parameter for the serving cell.

Some aspects described herein relate to an apparatus for wireless communication. The apparatus may include means for transmitting configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The apparatus may include means for receiving information identifying a set of PHR parameters for a serving cell, wherein the set of PHR parameters includes an SBFD PHR parameter and a non-SBFD PHR parameter for the serving cell.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of full-duplex communication in a wireless network.

FIG. 4 is a diagram illustrating an example of transmission configuration indicator (TCI) states for sub-bands.

FIGS. 5A and 5B are diagrams illustrating an example associated with determining power headroom for sub-band full-duplex (SBFD) aware user equipment (UE) operation.

FIG. 6 is a diagram illustrating an example process performed, for example, at a UE or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

A user equipment (UE) may be scheduled to communicate using sub-band full-duplex (SBFD) symbols and non-SBFD symbols. In SBFD symbols, a communication bandwidth of the UE or a network node may be divided into communication in a first direction (e.g., an uplink direction) and communication in a second direction (e.g., a downlink direction). In the non-SBFD symbols, the communication bandwidth of the UE or the network node may be associated with a single direction (e.g., the uplink direction or the downlink direction). The UE may support separate power control procedures for SBFD symbols and for non-SBFD symbols in a single transmit receive point (TRP) communication deployment. Multiple TRP (multi-TRP) communication has been introduced to improve a throughput or coverage area of a network.

A UE may receive configuration information associated with configuring a transmission configuration indicator (TCI) state for the UE. Each TCI state is configured with up to two sets of power control (PC) parameters, and each PC parameter set may be associated with a particular duplex type (e.g., SBFD or non-SBFD). The PC parameters of a PC parameter set include a reference power level p0, a power control rate change parameter a, or a closed loop power control index (CLI), among other examples. Additionally, or alternatively, a TCI state may be associated with a pathloss reference signal (PL-RS) for SBFD operation or non-SBFD operation. When a TCI state is configured with two sets of PC parameters and is not associated with a particular duplex type, the UE may utilize each set of PC parameters (and an associated PL-RS) for up-link transmission based on a duplex type. If only a single set of PC parameters is configured for a TCI state, the UE may use the single set of PC parameters for both duplex types. However, for an SBFD-aware UE, the network node and the UE may not have a power headroom (PHR) parameter that is specific to a duplex type. Accordingly, the UE may not report a PHR parameter that the network node can use for power control.

Various aspects relate generally to determining a PHR for SBFD-aware UE operation. Some aspects more specifically relate to conditions under which a UE is to determine two separate PHRs for SBFD symbols and non-SBFD symbols. In some aspects, the UE May determine that a set of conditions are satisfied and may determine and report a first PHR for uplink transmission in SBFD symbols and a second PHR for uplink transmission in non-SBFD symbols. In some aspects, the UE may determine the one or more PHRs based on an actual communication (e.g., a physical uplink shared channel (PUSCH) communication or sounding reference signal (SRS)) or a reference (e.g., virtual) communication (e.g., a reference PUSCH communication or a reference SRS).

Particular aspects of the subject matter described in this disclosure can be implemented to realize one or more of the following potential advantages. In some examples, the described techniques can be used to improve PHR determination and reporting in mixed SBFD and non-SBFD communication modes. In some examples, the described techniques can be used to maintain synchronization between a UE and a network node by providing deterministic conditions for when the UE is to determine a single PHR or a set of PHRs as well as by specifying a procedure for determining one or more PHRs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

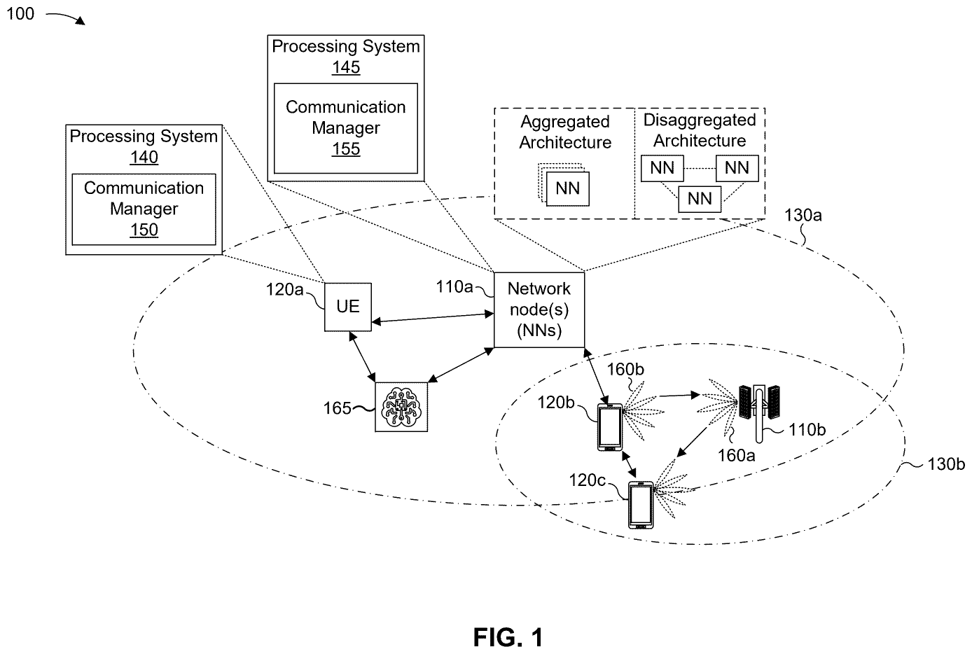

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHZ through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a TRP, a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a TCI state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

The network node 110 may provide the UE 120 with a configuration of TCI states that indicate or correspond to beams that may be used by the UE 120, such as for receiving one or more communications via a physical channel. For example, the network node 110 may indicate (for example, using DCI) an activated TCI state to the UE 120, which the UE 120 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or an SRS set ID, among other examples. A TCI state information element (sometimes referred to as a TCI state herein) may indicate particular information associated with a beam. For example, the TCI state information element may indicate a TCI state identification (for example, a tci-StateID), a QCL type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-ResourceId or an SSB-Index, among other examples). Spatial relation information may similarly indicate information associated with an uplink beam. The beam indication may be a joint or separate DL/UL beam indication in a unified TCI framework. In a unified TCI framework, a network node 110 may support common TCI state ID update and activation, which may provide common QCL and/or common UL transmission spatial filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some examples, the network may support a layer 1 (L1)-based beam indication using at least UE-specific (unicast) DCI to indicate joint or separate DL/UL beam indications that may be selected from active TCI states. In some examples, DCI formats 1_1 and/or 1_2 may be used for beam indication. The network node 110 may include a support mechanism for the UE 120 to acknowledge successful decoding of a beam indication. For example, the acknowledgment/negative acknowledgment of the PDSCH scheduled by the DCI carrying the beam indication may also be used as an acknowledgement for the DCI.

In some aspects, the UE 120 may include a communication manager 150. As described in more detail elsewhere herein, the communication manager 150 may receive configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation; and transmit information identifying a set of PHR parameters for a serving cell, wherein the set of PHR parameters includes an SBFD PHR parameter and a non-SBFD PHR parameter for the serving cell. Additionally, or alternatively, the communication manager 150 may perform one or more other operations described herein.

In some aspects, the network node 110 may include a communication manager 155. As described in more detail elsewhere herein, the communication manager 155 may transmit configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation; and receive information identifying a set of PHR parameters for a serving cell, wherein the set of PHR parameters includes an SBFD PHR parameter and a non-SBFD PHR parameter for the serving cell. Additionally, or alternatively, the communication manager 155 may perform one or more other operations described herein.

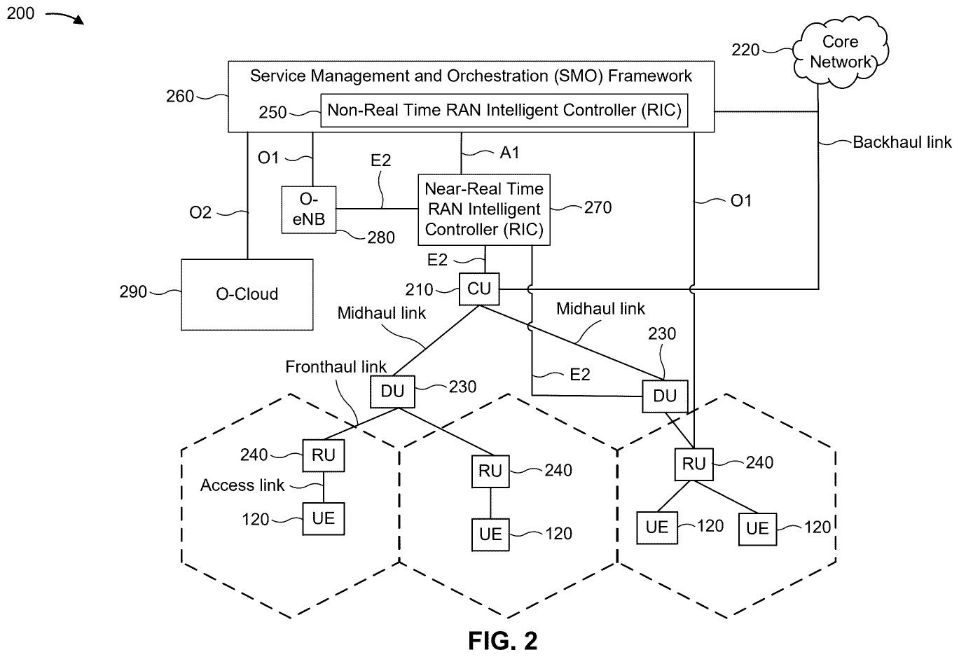

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

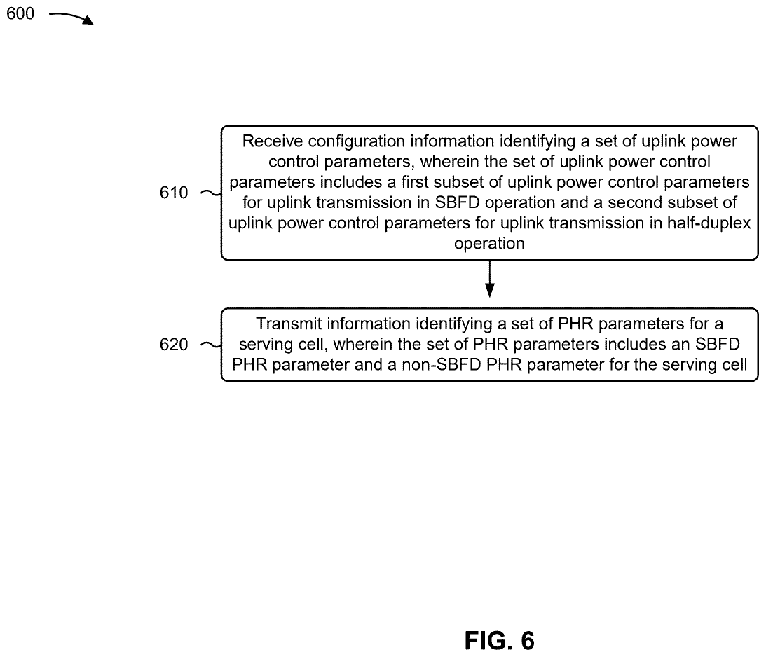

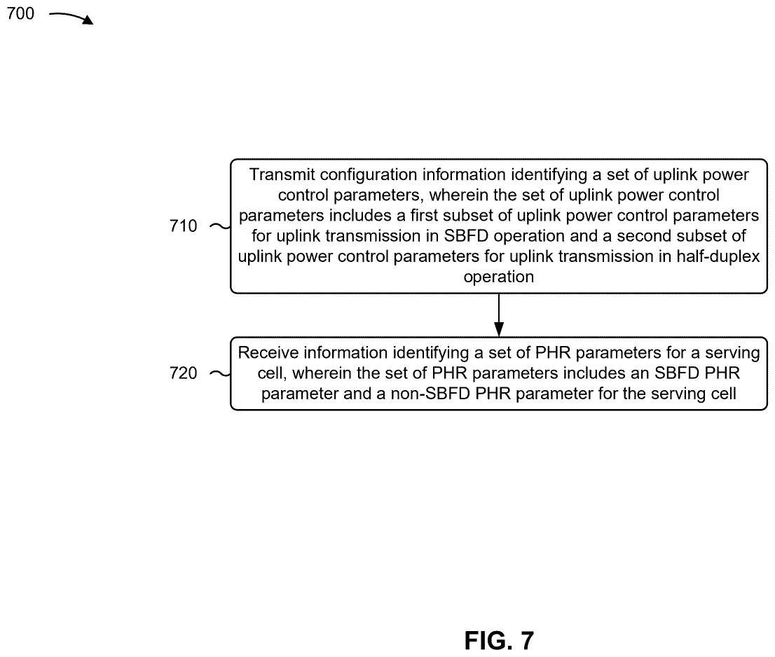

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with determining power headroom for SBFD aware UE operation, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

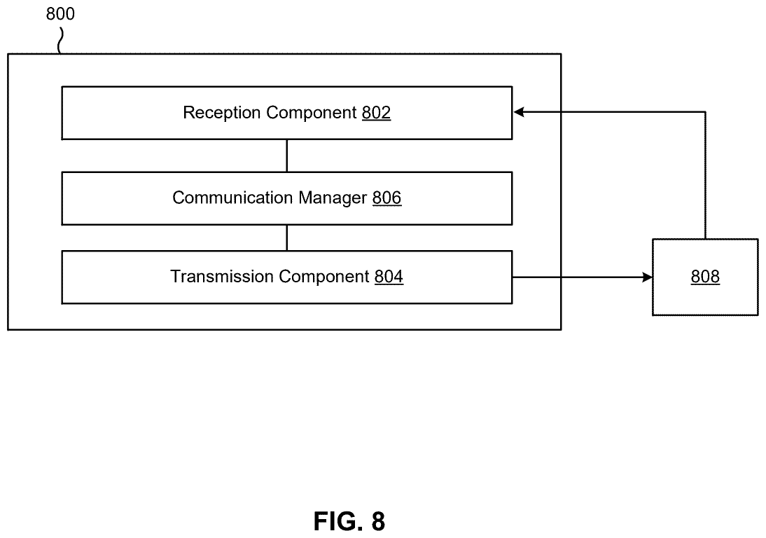

In some aspects, the UE 120 includes means for receiving configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation; and/or means for transmitting information identifying a set of PHR parameters for a serving cell, wherein the set of PHR parameters includes an SBFD PHR parameter and a non-SBFD PHR parameter for the serving cell. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

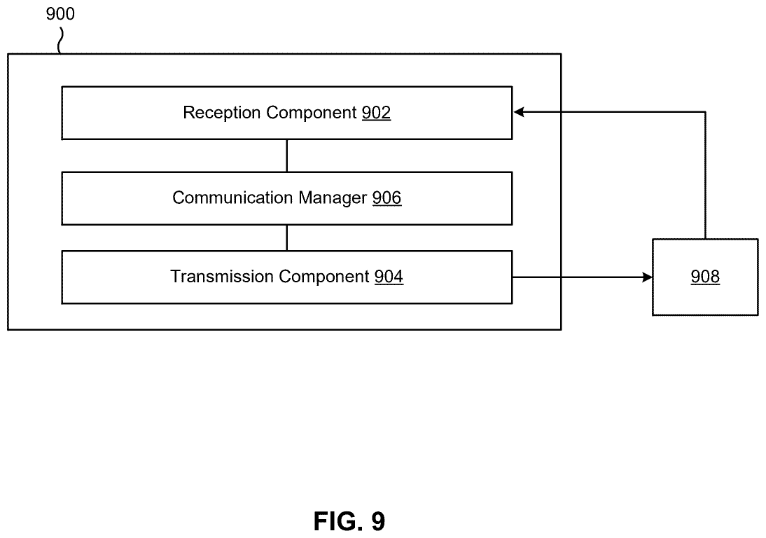

In some aspects, the network node 110 includes means for transmitting configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation; and/or means for receiving information identifying a set of PHR parameters for a serving cell, wherein the set of PHR parameters includes an SBFD PHR parameter and a non-SBFD PHR parameter for the serving cell. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

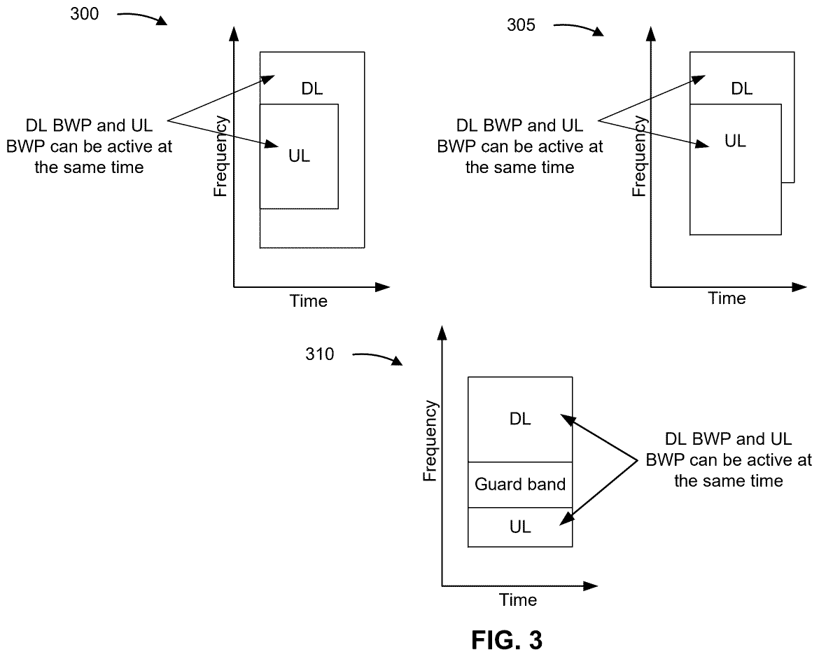

FIG. 3 is a diagram illustrating examples 300, 305, and 310 of full-duplex communication in a wireless network. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 3, examples 300 and 305 show examples of in-band full-duplex (IBFD) communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 3 is provided as an example. Other examples may differ from what is described with respect to FIG. 3.

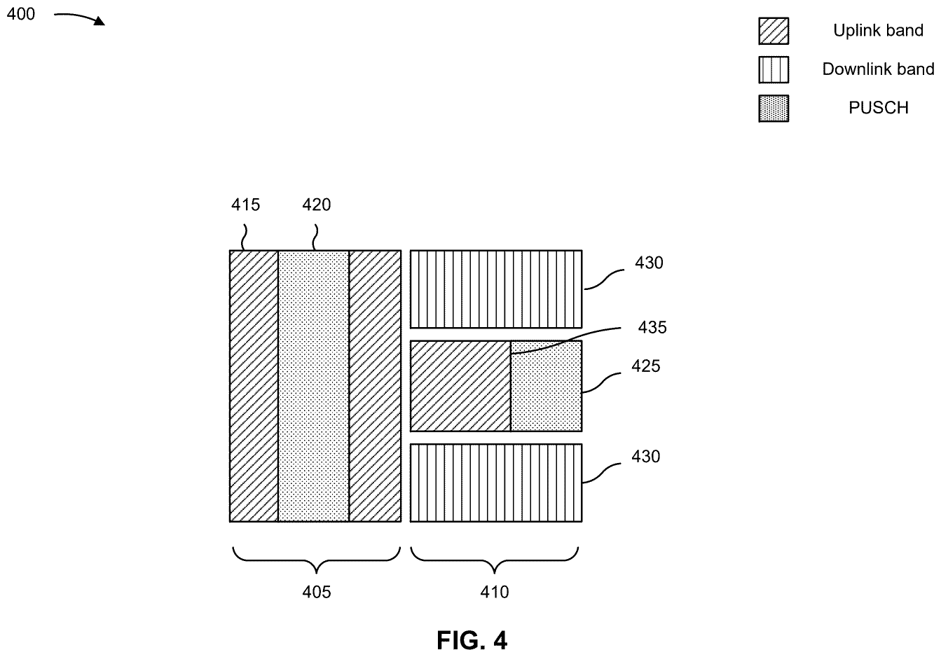

FIG. 4 is a diagram illustrating an example 400 of TCI states for sub-bands. As shown in FIG. 4, a set of resources may include a non-SBFD resource 405 and an SBFD resource 410. The non-SBFD resource 405 may include uplink resource 415 in which a PUSCH 420 is scheduled. The SBFD resource may include an uplink resource 425 and a downlink resource 430. Within the uplink resource 425 is scheduled a PUSCH 435.

In a first example, when a TCI state is configured with two sets of power control (PC) parameters and the TCI state is not associated with a specific duplex type, the UE may utilize each set of PC parameters and an associated pathloss reference signal (PL-RS) for uplink transmission based on a duplex type. In this case, a UE may semi-statically switch the PC parameters for uplink transmission based on a symbol type. For example, a UE may use a first set of PC parameters for non-SBFD resource transmission and may use a second set of PC parameters for SBFD resource transmission. In this case, a first uplink TCI state may include a first set of PC parameters that a UE uses for transmission of PUSCH 420 in non-SBFD resource 405 and a second set of PC parameters that the UE uses for transmission of PUSCH 435 in SBFD resource 410. If only a single set of PC parameters is configured, the UE may use the same set of PC parameters for both SBFD and non-SBFD symbols. In some examples, SBFD-aware UEs may be configured with two sets of PC parameters per TCI state.

In a second example, when a TCI state is configured with two sets of PC parameters and is activated for a duplex-specific symbol, the UE may utilize the activated set of PC parameters and an associated PL-RS for uplink transmission based on a duplex type. For example, an indicated TCI state may be associated with a duplex-specific mode based on an activating MAC-CE command (e.g., an explicit bitfield to indicate a duplex type of the activated TCI state) or based on an indicating DCI format. In this case, the UE 120 may use a first TCI state with a first set of PC parameters for transmission of PUSCH 420 in non-SBFD resource 405 and a second TCI state with a second set of PC parameters for transmission of PUSCH 435 in SBFD resource 410.

As indicated above, FIG. 4 is provided as an example. Other examples may differ from what is described with respect to FIG. 4.

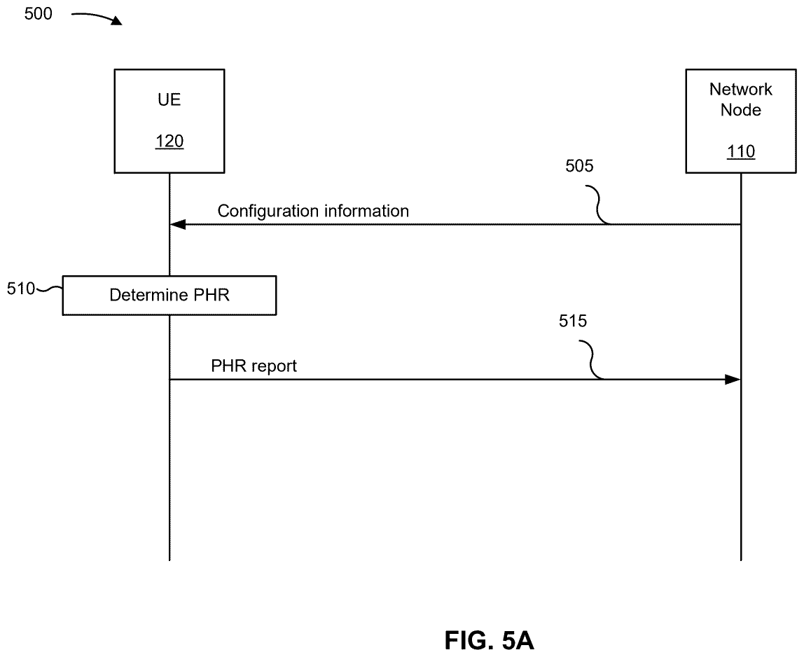

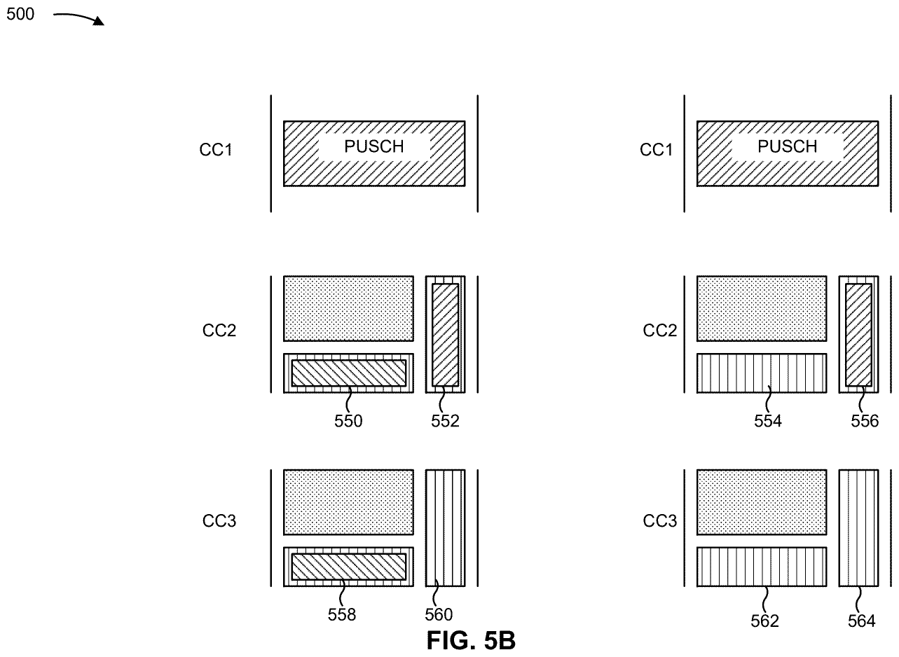

FIGS. 5A and 5B are diagrams illustrating an example 500 associated with determining power headroom for SBFD aware UE operation. As shown in FIG. 5A, example 500 includes communication between a network node 110 and a UE 120.

As further shown in FIG. 5A, and by reference number 505, the UE 120 may receive configuration information. For example, the UE 120 may receive, from the network node 110, RRC signaling associated with indicating a configuration associated with PHR reporting. In some aspects, the RRC signaling is based on a UE reporting capability. For example, the UE 120 may indicate support for determining two power headroom values, and the network node 110 may set a twoPHRmode parameter based on receiving the UE capability indicator. Additionally, or alternatively, the UE 120 may indicate support for dynamic waveform switching, and the network node 110 may configure the UE 120 to report power headroom values for different waveforms, as described in more detail herein.

In some aspects, the network node 110 may configure a set of parameters in the configuration information. For example, for an active uplink bandwidth part of a carrier of a serving cell, the network node 110 may configure an SBFD resource parameter, a PHR mode parameter, an SRS resource set parameter, or a TCI state list parameter, among other examples.

The SBFD resource parameter may include an SBFD time or frequency resource configuration for the carrier (e.g., for an SBFD cell). The PHR mode parameter (e.g., a parameter twoPHRmode) may include a parameter identifying whether a two PHR mode or a one PHR mode is configured (e.g., whether the network node 110 is configuring the UE 120 to report two PHR values or one PHR value). The SRS resource set parameter may include an indication of two SRS resource sets (e.g., in an srs-ResrouceSetToAddModList or an srs-ResourceSetToAddModListDCI-0-2 parameter) with a usage indicator set to a value of codebook or nonCodebook. The TCI state list parameter may include an information element (e.g., dl-OrJointTCIStateList or TCI-UL-State) that is configured or associated with two sets of PC parameters for uplink transmission in SBFD operation and in non-SBFD operation (e.g., another type of duplex operation or half-duplex operation). The sets of PC parameters may include a p0 parameter, an a parameter, or a closedLoop parameter, among other examples. Based on receiving configuration information set with the aforementioned parameters, the UE 120 may determine that the UE 120 is to determine two PHRs associated with one or more TCI states configured with two PC parameter sets for uplink transmission (e.g., SRS, PUSCH, or PUCCH transmission) in SBFD symbols and non-SBFD symbols. As described in more detail herein, the two PHRs may be based on a measurement of an actual PUSCH transmission or a reference (e.g., virtual) PUSCH transmission.

As further shown in FIG. 5A, and by reference number 510, the UE 120 may determine a power headroom. For example, the UE 120 may determine information for a PHR report (e.g., a set of PC parameters). In some aspects, the PHR report is based on an actual transmission (e.g., an actual PUSCH or an actual SRS) or a reference (e.g., virtual) transmission (e.g., a reference PUSCH or a reference SRS). For example, as shown in FIG. 5B, and a set of component carriers (CC) may be scheduled for PUSCH transmission. For example, a CC1 may be scheduled for PUSCH transmission. In contrast, a CC2 and a CC3 may be scheduled as having an SBFD resource and a non-SBFD resource. As shown by reference number 550, in the SBFD resource of CC2 at a first time, a PUSCH transmission may be scheduled, so a PHR report based on the SBFD resource may be based on an actual PUSCH transmission. Similarly, as shown by reference number 552, in the non-SBFD resource of CC2 at the first time, a PUSCH transmission may be scheduled, so the PHR report based on the non-SBFD resource may be based on an actual PUSCH transmission. In contrast, at a second time, a PUSCH transmission is not scheduled in the SBFD resource, as shown by reference number 554, and is scheduled in the non-SBFD resource, as shown by reference number 556. Accordingly, at the second time, for CC2, the SBFD PHR report is based on a reference PUSCH transmission and the non-SBFD PHR report is based on an actual PUSCH transmission.

In another example, at the first time for the CC3, a PUSCH transmission is scheduled in the SBFD resource, as shown by reference number 558, and is not scheduled in the non-SBFD resource, as shown by reference number 560. Accordingly, at the first time, for CC3, the SBFD PHR report is based on an actual PUSCH transmission and the non-SBFD PHR report is based on a reference PUSCH transmission. In another example, at the second time for the CC3, a PUSCH transmission is not scheduled in the SBFD resource, as shown by reference number 562, and is not scheduled in the non-SBFD resource, as shown by reference number 564. Accordingly, at the second time, for CC3, the SBFD PHR report is based on a reference PUSCH transmission and the non-SBFD PHR report is based on a reference PUSCH transmission.

In some aspects, whether the PHR report is based on an actual PUSCH transmission or a reference PUSCH transmission may be based on a set of parameters. For example, when the UE 120 is configured, for an active BWP of a carrier of an SBFD serving cell with a twoPHRmode parameter, two SRS resourceSets, and the same TCI state with respective PC parameter sets for SBFD symbols and non-SBFD symbols, the UE 120 may provide a first type-1 PHR report (and a first configured maximum output power) associated with an SBFD PC parameter (e.g., a parameter p0AlphaSetforPUSCH or a parameter pathlossReferenceRS-Id-r17) of a TCI state for an actual or reference PUSCH transmission in one or more SBFD symbols. Additionally, or alternatively, the UE 120 may provide a second type-1 PHR report (and a second configured maximum output power) associated with a non-SBFD PC parameter of the same TCI state for an actual or reference PUSCH transmission in one or more non-SBFD symbols. Additionally, or alternatively, when the UE 120 is configured, for an active BWP of a carrier of an SBFD serving cell with a twoPHRmode parameter, two SRS resourceSets, and separate TCI states with respective PC parameter sets for SBFD symbols and non-SBFD symbols, the UE 120 may provide a first type-1 PHR report (and a first configured maximum output power) associated with an SBFD PC parameter (e.g., a parameter p0AlphaSetforPUSCH or a parameter pathlossReferenceRS-Id-r17) of a first SBFD TCI state for an actual or reference PUSCH transmission in one or more SBFD symbols. Additionally, or alternatively, the UE 120 may provide a second type-1 PHR report (and a second configured maximum output power) associated with a non-SBFD PC parameter of a second (non-SBFD) TCI state for an actual or reference PUSCH transmission in one or more non-SBFD symbols. In other examples, where a cell is not configured with a PUSCH configuration, the UE 120 computes two type-3 PHRs based on an actual or reference SRS transmission in SBFD and non-SBFD symbols.

Additionally, or alternatively, when the twoPHRmode parameter is not configured (or is not set to a value indicating reporting of two PHR values), the UE 120 may provide, for an actual PUSCH transmission in a slot associated with a PHR, a type-1 PHR (and a configured maximum output power) that is based on a first actual PUSCH transmission in the slot. In this case, the UE 120 may indicate a duplex type of the reported PHR value. Additionally, or alternatively, the UE 120 may provide a type-1 PHR based on an actual PUSCH associated with a first (or second) PC parameter in a TCI state (e.g., whichever PC parameter is associated with SBFD symbols). Additionally, or alternatively, the UE 120 may provide a type-1 PHR based on an actual PUSCH associated with a first (or second) TCI state (e.g., a TCI state in an active TCI codepoint for SBFD). Additionally, or alternatively, the UE 120 may provide a type-1 PHR based on an actual PUSCH transmission associated with a first symbol type of a slot in which the PHR is reported. Additionally, or alternatively, when there is not an actual PUSCH transmission in a slot conveying a PHR, the UE 120 may provide a type-1 PHR based on a reference PUSCH transmission, such as a reference PUSCH transmission associated with a first (or second) PC parameter in a TCI state, associated with a first (or second) TCI state in an active TCI codepoint, associated with an SBFD symbol PC parameter, associated with an SBFD TCI state, or associated with a symbol type of a slot in which the PHR is reported.

In some aspects, the UE 120 may determine different PHR values associated with different waveforms. For example, when the UE 120 is configured for dynamic waveform switching (DWS) and SBFD operation, and the UE 120 is configured with the twoPHRmode parameter for SBFD symbols and non-SBFD symbols, the UE 120 may determine two PH values based on actual or reference PUSCH transmissions for a current waveform type (e.g., DFT-s-OFDM or CP-OFDM) in SBFD symbols and two PH values for another waveform for a virtual PUSCH transmission in one or more SBFD symbols and non-SBFD symbols.

In some aspects, the UE 120 may calculate a type-1 PHR report for an activated serving cell based on an actual PUSCH transmission. For example, for a PUSCH transmission occasion i in one or more SBFD symbols (or non-SBFD symbols) on an active uplink BWP b for a carrier f of a serving cell c, the UE 120 may determine a PHR parameter according to an equation:

$$P {H}_{type 1 , b , f , c} ( i , j , {q}_{d} , l ) = {P}_{C M A X , f , c} ( i ) - \{ {P}_{{0}_{P U SCH} , b , f , c} ( j ) + 10 {log}_{10} ( {2}^{μ} \cdot {M}_{RB , b , f , c}^{P U S C H} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \}$$

where PH is the PHR parameter and values for P_{0_PUSCH,b,f,c}(j), α_{b,f,c}(j), and a PUSCH power control adjustment state l are provided by the one or more SBFD symbols (or non-SBFD symbols). The p0AlphaSet parameter associated SBFD power control parameters (or non-SBFD power control parameters) is configured within an indicated TCI state. Additional details regarding PHR calculation are described in 3GPP Technical Specification (TS) 38.213, Version 18.5.0.

Additionally, or alternatively, the UE 120 may determine a type-3 PHR report for an activated serving cell based on an actual SRS transmission. For example, for an SRS transmission occasion i in one or more SBFD symbols (or non-SBFD symbols) on an active uplink BWP b for a carrier f of a serving cell c, the UE 120 may determine a PHR parameter according to an equation:

$$P {H}_{t ype 3 , b , f , c} ( i , {q}_{s} ) = {P}_{C M A X , f , c} ( i ) - \{ {P}_{{0}_{S R S} , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i ) \}$$

where values for P_{CMAX,f,c}, P_{0_SRS,b,f,c}(qₛ), α_{SRS,b,f,c}(j), and an SRS power control adjustment state l are provided by the one or more SBFD symbols (or non-SBFD symbols). The p0AlphaSet power control parameter is associated with an indicated TCI state.

Additionally, or alternatively, the UE 120 may determine a type-1 PHR report for an activated serving cell based on a reference PUSCH transmission (e.g., a virtual PUSCH transmission). For example, for a PUSCH transmission occasion i in one or more SBFD symbols (or non-SBFD symbols) on an active uplink BWP b for a carrier f of a serving cell c, the UE 120 may determine a PHR parameter according to an equation:

$$P {H}_{type 1 , b , f , c} ( i , {q}_{s} ) = {\tilde{P}}_{CMAX , f , c} ( i ) - \{ {P}_{{0}_{P U S C H} b , f , c} ( j ) + {α}_{b , f , c} ( j ) \cdot {PL}_{b , f , c} ( {q}_{d} ) + {h}_{b , f , c} ( i ) \}$$

where values for P_{0_PUSCH,b,f,c}(j), α_{b,f,c}(j), and a PUSCH power control adjustment state l are provided by the one or more SBFD symbols (or non-SBFD symbols). The p0AlphaSet parameter is associated with an indicated TCI state.

Additionally, or alternatively, the UE 120 may determine a type-3 PHR report for an activated serving cell based on a reference SRS transmission. For example, for an SRS transmission occasion i in one or more SBFD symbols (or non-SBFD symbols) on an active uplink BWP b for a carrier f of a serving cell c, the UE 120 may determine a PHR parameter according to an equation:

$$P {H}_{t ype 3 , b , f , c} ( i , {q}_{s} ) = {\tilde{P}}_{CMAX , f , c} ( i ) - \{ {P}_{{0}_{S R S} , b , f , c} ( {q}_{s} ) + {α}_{S R S , b , f , c} ( {q}_{s} ) \cdot {PL}_{b , f , c} ( {q}_{d} ) + {h}_{b , f , c} ( i ) \}$$

where values for P_{CMAX,f,c}, P_{0_SRS,b,f,c}(qₛ), α_{SRS,b,f,c}(j), and an SRS power control adjustment state l are provided by the one or more SBFD symbols' (or non-SBFD symbols') p0AlphaSet power control parameter associated with an indicated TCI state.

In some aspects, the UE 120 may generate a PHR report. For example, the UE 120 may generate a PHR report that includes two PHR values. In this case, when the same TCI state is used for an SBFD cell and a non-SBFD cell and when the UE 120 is configured to generate a PHR report with two PHR values, the UE 120 may order the reported PHR values in accordance with whether the reported PHR values are for the SBFD cell or the non-SBFD cell. For example, the UE 120 may include a first reported PHR value that is a PHR value associated with a real or reference PUSCH transmission in one or more SBFD symbols and a second reported PHR value that is a PHR value associated with a real or reference PUSCH transmission in non-SBFD symbols. Additionally, or alternatively, the UE 120 may include a bit indicator of whether a PHR value is for SBFD symbols or non-SBFD symbols. For example, the UE 120 may set a bit of a MAC-CE to indicate a duplex type of a particular reported PHR value. Additionally, or alternatively, when different TCI states are used for an SBFD cell and a non-SBFD cell, the UE 120 may order PHR values based on a duplex type of a TCI state. In other words, the UE 120 may include, as a first reported PHR value, a PHR value associated with an SBFD-specific TCI state or a TCI-UL-State parameter for a real or reference PUSCH transmission in one or more SBFD symbols and may include, as a second reported PHR value, a PHR value associated with a non-SBFD TCI state for a real or reference PUSCH transmission in one or more non-SBFD symbols. Additionally, or alternatively, the UE 120 may include a bit indicator (e.g., in a MAC-CE) to indicate a duplex-type of a TCI state that is associated with a reported PHR value.

In some aspects, the UE 120 may generate a MAC-CE for a single-entry PHR for SBFD operation. For example, the UE 120 may generate, using a MAC entity, a single entry PHR report for a single TRP SBFD based on a set of PHR values determined at a physical layer. The MAC-CE may include a first set of bits for a first PH value (e.g., a type-1 PHR for a primary cell) and a second set of bits for a second PH value (e.g., a type-1 PHR for a primary cell). In this case, the first PH value may be associated with one or more SBFD symbols and the second PH value may be associated with one or more non-SBFD symbols, as described above. For example, the UE 120 may, if a MAC entity is configured with twoPHRMode and a serving cell is configured with SBFD operation, instruct a multiplexing and assembly procedure to generate and transmit the Enhanced Single Entry PHR for single TRP SBFD based on the values reported by the physical layer. When there are multiple PHRs being reported for a set of serving cells, if a serving cell is configured with SBFD operation (not configured with multipanelSchemeSDM, multipanelSchemeSFN, or mTPR PUSCH repetition) and the MAC entity of the UE 120 may, for the Serving Cell configured with twoPHRMode, obtain two values of a type-1 or a type-3 power headroom for an uplink carrier. If a serving cell is configured with SBFD operation, the UE 120 may obtain a value of a type-1 power headroom of a first real transmission of the corresponding uplink carrier. If a Serving Cell is configured with SBFD operation, the UE 120 may obtain a value of a type-1 power headroom of a reference PUSCH transmission.

As further shown in FIG. 5A, and by reference number 515, the UE 120 may transmit a PHR report. For example, the UE 120 may transmit a MAC-CE conveying one or more PH values to convey a PHR report to the network node 110. Based on the PHR report, the network node 110 may configure one or more subsequent communications, such as one or more subsequent transmissions or receptions.

As indicated above, FIGS. 5A and 5B are provided as examples. Other examples may differ from what is described with respect to FIGS. 5A and 5B.

FIG. 6 is a diagram illustrating an example process 600 performed, for example, at a UE or an apparatus of a UE. Example process 600 is an example where the apparatus or the UE (e.g., UE 120) performs operations associated with techniques for determining power headroom for SBFD-aware UE operation.

As shown in FIG. 6, in some aspects, process 600 may include receiving configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation (block 610). For example, the UE (e.g., using reception component 802 or communication manager 806, depicted in FIG. 8) may receive configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation, as described above.

As further shown in FIG. 6, in some aspects, process 600 may include transmitting information identifying a set of PHR parameters for a serving cell, wherein the set of PHR parameters includes an SBFD PHR parameter and a non-SBFD PHR parameter for the serving cell (block 620). For example, the UE (e.g., using transmission component 804 or communication manager 806, depicted in FIG. 8) may transmit information identifying a set of PHR parameters for a serving cell, wherein the set of PHR parameters includes an SBFD PHR parameter and a non-SBFD PHR parameter for the serving cell, as described above.

Process 600 may include additional aspects, such as any single aspect or any combination of aspects described below or in connection with one or more other processes described elsewhere herein.

In a first aspect, receiving the configuration information comprises receiving information identifying at least one of an SBFD resource configuration parameter, a PHR mode parameter, a plurality of SRS resource set parameters, or a TCI state configured with SBFD-specific and non-SBFD specific power parameters.

In a second aspect, alone or in combination with the first aspect, whether the UE reports a single PHR parameter or two PHR parameters is based on a configuration of the set of uplink power control parameters.

In a third aspect, alone or in combination with one or more of the first and second aspects, a PHR parameter is based on at least one of a PUSCH transmission, a SRS transmission, a reference PUSCH transmission, or a reference SRS transmission.

In a fourth aspect, alone or in combination with one or more of the first through third aspects, the SBFD PHR parameter is a first PHR parameter based on a transmission in one or more SBFD symbols or is associated with an SBFD TCI state, and wherein the non-SBFD PHR parameter is a second PHR parameter based on a transmission in one or more non-SBFD symbols or is associated with a non-SBFD TCI state.

In a fifth aspect, alone or in combination with one or more of the first through fourth aspects, the SBFD PHR parameter includes a first type-1 PHR parameter associated with the first subset of uplink power control parameters and of a TCI state for a first transmission in one or more SBFD symbols, and wherein the non-SBFD PHR parameter includes a second type-1 PHR parameter associated with the second subset of uplink power control parameters and of the TCI state.

In a sixth aspect, alone or in combination with one or more of the first through fifth aspects, the SBFD PHR parameter includes a first type-1 PHR parameter associated with an SBFD TCI state and for a first transmission in one or more SBFD symbols using a spatial domain filter, and includes an SBFD-specific uplink power control parameter of the SBFD TCI state, and wherein the non-SBFD PHR parameter includes a second type-1 PHR parameter associated with a non-SBFD TCI state for a second transmission in one or more non-SBFD symbols using the spatial domain filter, and includes a non-SBFD-specific uplink power control parameter of the non-SBFD TCI state.

In a seventh aspect, alone or in combination with one or more of the first through sixth aspects, the set of PHR parameters is based on at least one of a first PUSCH transmission in a slot, a PUSCH transmission associated with a first uplink power control parameter in a transmission configuration indicator state, a PUSCH transmission associated with a first TCI state, or a PUSCH transmission associated with a first symbol type of a slot in which the set of PHR parameters is reported.

In an eighth aspect, alone or in combination with one or more of the first through seventh aspects, the set of PHR parameters is based on at least one of a first reference PUSCH transmission in a slot, a reference PUSCH transmission associated with a first uplink power control parameter in a transmission configuration indicator state, a reference PUSCH transmission associated with a first TCI state, a reference PUSCH transmission associated with a first symbol type of a slot in which the set of PHR parameters is reported, a reference PUSCH transmission associated with an SBFD symbol uplink power control parameter, or a reference PUSCH associated with an SBFD TCI state.

In a ninth aspect, alone or in combination with one or more of the first through eighth aspects, the information identifying the set of PHR parameters is a single entry PHR parameter for a single transmit receive point SBFD.

In a tenth aspect, alone or in combination with one or more of the first through ninth aspects, the set of PHR parameters includes one or more PHR parameters for a first waveform and one or more PHR parameters for a second waveform.

In an eleventh aspect, alone or in combination with one or more of the first through tenth aspects, a quantity of PHR parameters in the set of PHR parameters is based on a UE capability indication.

In a twelfth aspect, alone or in combination with one or more of the first through eleventh aspects, within a reporting message, the SBFD PHR parameter is before the non-SBFD PHR parameter.

In a thirteenth aspect, alone or in combination with one or more of the first through twelfth aspects, within a reporting message, a bit indicator identifies whether a PHR parameter is the SBFD PHR parameter or is the non-SBFD PHR parameter.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with techniques for determining power headroom for SBFD-aware UE operation.

As shown in FIG. 7, in some aspects, process 700 may include transmitting configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation (block 710). For example, the network node (e.g., using transmission component 904 or communication manager 906, depicted in FIG. 9) may transmit configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation, as described above.

As further shown in FIG. 7, in some aspects, process 700 may include receiving information identifying a set of PHR parameters for a serving cell, wherein the set of PHR parameters includes an SBFD PHR parameter and a non-SBFD PHR parameter for the serving cell (block 720). For example, the network node (e.g., using reception component 902 or communication manager 906, depicted in FIG. 9) may receive information identifying a set of PHR parameters for a serving cell, wherein the set of PHR parameters includes an SBFD PHR parameter and a non-SBFD PHR parameter for the serving cell, as described above.

Process 700 may include additional aspects, such as any single aspect or any combination of aspects described below or in connection with one or more other processes described elsewhere herein.

In a first aspect, transmitting the configuration information comprises transmitting information identifying at least one of an SBFD resource configuration parameter, a PHR mode parameter, a plurality of SRS resource set parameters, or a TCI state configured with SBFD-specific and non-SBFD specific power parameters.

In a second aspect, alone or in combination with the first aspect, whether a PHR report includes a single PHR parameter or two PHR parameters based on a configuration of the set of uplink power control parameters.

In a third aspect, alone or in combination with one or more of the first and second aspects, a PHR parameter is based on at least one of a PUSCH transmission, a SRS transmission, a reference PUSCH transmission, or a reference SRS transmission.

In a fourth aspect, alone or in combination with one or more of the first through third aspects, the SBFD PHR parameter is a first PHR parameter based on a transmission in one or more SBFD symbols or is associated with an SBFD TCI state, and wherein the non-SBFD PHR parameter is a second PHR parameter based on a transmission in one or more non-SBFD symbols or is associated with a non-SBFD TCI state.

In a fifth aspect, alone or in combination with one or more of the first through fourth aspects, the SBFD PHR parameter includes a first type-1 PHR parameter associated with a first subset of uplink power control parameters of a TCI state for a first transmission in one or more SBFD symbols, and wherein the non-SBFD PHR parameter includes a second type-1 PHR parameter associated with a second subset of uplink power control parameters of the TCI state.

In a sixth aspect, alone or in combination with one or more of the first through fifth aspects, the SBFD PHR parameter includes a first type-1 PHR parameter associated with an SBFD TCI state and for a first transmission in one or more SBFD symbols using a spatial domain filter, and includes an SBFD-specific uplink power control parameter of the SBFD TCI state, and wherein the non-SBFD PHR parameter includes a second type-1 PHR parameter associated with a non-SBFD TCI state for a second transmission in one or more non-SBFD symbols using the spatial domain filter, and includes a non-SBFD-specific uplink power control parameter of the non-SBFD TCI state.

In a seventh aspect, alone or in combination with one or more of the first through sixth aspects, the set of PHR parameters is based on at least one of a first PUSCH transmission in a slot, a PUSCH transmission associated with a first uplink power control parameter in a transmission configuration indicator state, a PUSCH transmission associated with a first TCI state, or a PUSCH transmission associated with a first symbol type of a slot in which the set of PHR parameters is reported.

In an eighth aspect, alone or in combination with one or more of the first through seventh aspects, the set of PHR parameters is based on at least one of a first reference PUSCH transmission in a slot, a reference PUSCH transmission associated with a first uplink power control parameter in a transmission configuration indicator state, a reference PUSCH transmission associated with a first TCI state, a reference PUSCH transmission associated with a first symbol type of a slot in which the set of PHR parameters is reported, a reference PUSCH transmission associated with an SBFD symbol uplink power control parameter, or a reference PUSCH associated with an SBFD TCI state.

In a ninth aspect, alone or in combination with one or more of the first through eighth aspects, the information identifying the set of PHR parameters is a single entry PHR parameter for a single transmit receive point SBFD.

In a tenth aspect, alone or in combination with one or more of the first through ninth aspects, the set of PHR parameters includes one or more PHR parameters for a first waveform and one or more PHR parameters for a second waveform.

In an eleventh aspect, alone or in combination with one or more of the first through tenth aspects, a quantity of PHR parameters in the set of PHR parameters is based on a UE capability indication.

In a twelfth aspect, alone or in combination with one or more of the first through eleventh aspects, within a reporting message, the SBFD PHR parameter is before the non-SBFD PHR parameter.

In a thirteenth aspect, alone or in combination with one or more of the first through twelfth aspects, within a reporting message, a bit indicator identifies whether a PHR parameter is the SBFD PHR parameter or is the non-SBFD PHR parameter.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 5A-5B. Additionally, or alternatively, the apparatus 800 may be configured to perform one or more processes described herein, such as process 600 of FIG. 6. In some aspects, the apparatus 800 or one or more components shown in

FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The transmission component 804 may transmit information identifying a set of PHR parameters for a serving cell, wherein the set of PHR parameters includes an SBFD PHR parameter and a non-SBFD PHR parameter for the serving cell.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 5A-5B. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit configuration information identifying a set of uplink power control parameters, wherein the set of uplink power control parameters includes a first subset of uplink power control parameters for uplink transmission in SBFD operation and a second subset of uplink power control parameters for uplink transmission in half-duplex operation. The reception component 902 may receive information identifying a set of PHR parameters for a serving cell, wherein the set of PHR parameters includes an SBFD PHR parameter and a non-SBFD PHR parameter for the serving cell.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation; and transmitting information identifying a set of power headroom (PHR) parameters for a serving cell, wherein the set of PHR parameters includes an SBFD PHR parameter and a non-SBFD PHR parameter for the serving cell.
Aspect 2: The method of Aspect 1, wherein receiving the configuration information comprises receiving information identifying at least one of: an SBFD resource configuration parameter, a PHR mode parameter, a plurality of sounding reference signal (SRS) resource set parameters, or a transmission configuration indicator (TCI) state configured with SBFD-specific and non-SBFD specific power parameters.
Aspect 3: The method of Aspect 2, wherein whether the UE reports a single PHR parameter or two PHR parameters is based on a configuration of the set of uplink power control parameters.
Aspect 4: The method of any of Aspects 1-3, wherein a PHR parameter is based on at least one of: a physical uplink shared channel (PUSCH) transmission, a sounding reference signal (SRS) transmission, a reference PUSCH transmission, or a reference SRS transmission.
Aspect 5: The method of any of Aspects 1-4, wherein, within a reporting message, the SBFD PHR parameter is before the non-SBFD PHR parameter.
Aspect 6: The method of any of Aspects 1-5, wherein, within a reporting message, a bit indicator identifies whether a PHR parameter is the SBFD PHR parameter or is the non-SBFD PHR parameter.
Aspect 7: The method of any of Aspects 1-6, wherein the SBFD PHR parameter is a first PHR parameter based on a transmission in one or more SBFD symbols or is associated with an SBFD transmission configuration indicator (TCI) state, and wherein the non-SBFD PHR parameter is a second PHR parameter based on a transmission in one or more non-SBFD symbols or is associated with a non-SBFD TCI state.
Aspect 8: The method of any of Aspects 1-7, wherein the SBFD PHR parameter includes a first type-1 PHR parameter associated with the first subset of uplink power control parameters and of a transmission configuration indicator (TCI) state for a first transmission in one or more SBFD symbols, and wherein the non-SBFD PHR parameter includes a second type-1 PHR parameter associated with the second subset of uplink power control parameters and of the TCI state.
Aspect 9: The method of any of Aspects 1-8, wherein the SBFD PHR parameter includes a first type-1 PHR parameter associated with an SBFD transmission configuration indicator (TCI) state and for a first transmission in one or more SBFD symbols using a spatial domain filter, and includes an SBFD-specific uplink power control parameter of the SBFD TCI state, and wherein the non-SBFD PHR parameter includes a second type-1 PHR parameter associated with a non-SBFD TCI state for a second transmission in one or more non-SBFD symbols using the spatial domain filter, and includes a non-SBFD-specific uplink power control parameter of the non-SBFD TCI state.
Aspect 10: The method of any of Aspects 1-9, wherein the set of PHR parameters is based on at least one of: a first physical uplink shared channel (PUSCH) transmission in a slot, a PUSCH transmission associated with a first uplink power control parameter in a transmission configuration indicator state, a PUSCH transmission associated with a first TCI state, or a PUSCH transmission associated with a first symbol type of a slot in which the set of PHR parameters is reported.
Aspect 11: The method of any of Aspects 1-10, wherein the set of PHR parameters is based on at least one of: a first reference physical uplink shared channel (PUSCH) transmission in a slot, a reference PUSCH transmission associated with a first uplink power control parameter in a transmission configuration indicator state, a reference PUSCH transmission associated with a first TCI state, a reference PUSCH transmission associated with a first symbol type of a slot in which the set of PHR parameters is reported, a reference PUSCH transmission associated with an SBFD symbol uplink power control parameter, or a reference PUSCH associated with an SBFD TCI state.
Aspect 12: The method of any of Aspects 1-11, wherein the information identifying the set of PHR parameters is a single entry PHR parameter for a single transmit receive point SBFD.
Aspect 13: The method of any of Aspects 1-12, wherein the set of PHR parameters includes one or more PHR parameters for a first waveform and one or more PHR parameters for a second waveform.
Aspect 14: The method of any of Aspects 1-13, wherein a quantity of PHR parameters in the set of PHR parameters is based on a UE capability indication.
Aspect 15: A method of wireless communication performed by a network node, comprising: transmitting configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation; and receiving information identifying a set of power headroom (PHR) parameters for a serving cell, wherein the set of PHR parameters includes an SBFD PHR parameter and a non-SBFD PHR parameter for the serving cell.
Aspect 16: The method of Aspect 15, wherein transmitting the configuration information comprises transmitting information identifying at least one of: an SBFD resource configuration parameter, a PHR mode parameter, a plurality of sounding reference signal (SRS) resource set parameters, or a transmission configuration indicator (TCI) state configured with SBFD-specific and non-SBFD specific power parameters.
Aspect 17: The method of Aspect 16, wherein whether a PHR report includes a single PHR parameter or two PHR parameters based on a configuration of the set of uplink power control parameters.
Aspect 18: The method of any of Aspects 15-17, wherein a PHR parameter is based on at least one of: a physical uplink shared channel (PUSCH) transmission, a sounding reference signal (SRS) transmission, a reference PUSCH transmission, or a reference SRS transmission.
Aspect 19: The method of any of Aspects 15-18, wherein, within a reporting message, the SBFD PHR parameter is before the non-SBFD PHR parameter.
Aspect 20: The method of any of Aspects 15-19, wherein, within a reporting message, a bit indicator identifies whether a PHR parameter is the SBFD PHR parameter or is the non-SBFD PHR parameter.
Aspect 21: The method of any of Aspects 15-20, wherein the SBFD PHR parameter is a first PHR parameter based on a transmission in one or more SBFD symbols or is associated with an SBFD transmission configuration indicator (TCI) state, and wherein the non-SBFD PHR parameter is a second PHR parameter based on a transmission in one or more non-SBFD symbols or is associated with a non-SBFD TCI state.
Aspect 22: The method of any of Aspects 15-21, wherein the SBFD PHR parameter includes a first type-1 PHR parameter associated with a first subset of uplink power control parameters of a transmission configuration indicator (TCI) state for a first transmission in one or more SBFD symbols, and wherein the non-SBFD PHR parameter includes a second type-1 PHR parameter associated with a second subset of uplink power control parameters of the TCI state.
Aspect 23: The method of any of Aspects 15-22, wherein the SBFD PHR parameter includes a first type-1 PHR parameter associated with an SBFD transmission configuration indicator (TCI) state and for a first transmission in one or more SBFD symbols using a spatial domain filter, and includes an SBFD-specific uplink power control parameter of the SBFD TCI state, and wherein the non-SBFD PHR parameter includes a second type-1 PHR parameter associated with a non-SBFD TCI state for a second transmission in one or more non-SBFD symbols using the spatial domain filter, and includes a non-SBFD-specific uplink power control parameter of the non-SBFD TCI state.
Aspect 24: The method of any of Aspects 15-23, wherein the set of PHR parameters is based on at least one of: a first physical uplink shared channel (PUSCH) transmission in a slot, a PUSCH transmission associated with a first uplink power control parameter in a transmission configuration indicator state, a PUSCH transmission associated with a first TCI state, or a PUSCH transmission associated with a first symbol type of a slot in which the set of PHR parameters is reported.
Aspect 25: The method of any of Aspects 15-24, wherein the set of PHR parameters is based on at least one of: a first reference physical uplink shared channel (PUSCH) transmission in a slot, a reference PUSCH transmission associated with a first uplink power control parameter in a transmission configuration indicator state, a reference PUSCH transmission associated with a first TCI state, a reference PUSCH transmission associated with a first symbol type of a slot in which the set of PHR parameters is reported, a reference PUSCH transmission associated with an SBFD symbol uplink power control parameter, or a reference PUSCH associated with an SBFD TCI state.
Aspect 26: The method of any of Aspects 15-25, wherein the information identifying the set of PHR parameters is a single entry PHR parameter for a single transmit receive point SBFD.
Aspect 27: The method of any of Aspects 15-26, wherein the set of PHR parameters includes one or more PHR parameters for a first waveform and one or more PHR parameters for a second waveform.
Aspect 28: The method of any of Aspects 15-27, wherein a quantity of PHR parameters in the set of PHR parameters is based on a UE capability indication.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.
Aspect 36: A device comprising a processing system that includes one or more processors and one or more code-storing memories coupled with the one or more processors, the processing system configured to cause the device to perform the method of one or more of Aspects 1-28.
Aspect 37: A device comprising a processing system that includes processor circuitry and code-storing memory circuitry, the processing system configured to cause the device to perform the method of one or more of Aspects 1-28.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation; and
transmit information identifying a set of power headroom (PHR) parameters for a serving cell, wherein the set of PHR parameters includes an SBFD PHR parameter and a non-SBFD PHR parameter for the serving cell.

2. The UE of claim 1, wherein the processing system, to cause the UE to receive the configuration information, is configured to cause the UE to receive information identifying at least one of:
an SBFD resource configuration parameter,
a PHR mode parameter,
a plurality of sounding reference signal (SRS) resource set parameters, or
a transmission configuration indicator (TCI) state configured with SBFD-specific and non-SBFD specific power parameters.

3. The UE of claim 2, wherein whether the UE reports a single PHR parameter or two PHR parameters is based on a configuration of the set of uplink power control parameters.

4. The UE of claim 1, wherein a PHR parameter is based on at least one of:
a physical uplink shared channel (PUSCH) transmission,
a sounding reference signal (SRS) transmission,
a reference PUSCH transmission, or
a reference SRS transmission.

5. The UE of claim 1, wherein, within a reporting message, the SBFD PHR parameter is before the non-SBFD PHR parameter.

6. The UE of claim 1, wherein, within a reporting message, a bit indicator identifies whether a PHR parameter is the SBFD PHR parameter or is the non-SBFD PHR parameter.

7. The UE of claim 1, wherein the SBFD PHR parameter is a first PHR parameter based on a transmission in one or more SBFD symbols or is associated with an SBFD transmission configuration indicator (TCI) state, and
wherein the non-SBFD PHR parameter is a second PHR parameter based on a transmission in one or more non-SBFD symbols or is associated with a non-SBFD TCI state.

8. The UE of claim 1, wherein the SBFD PHR parameter includes a first type-1 PHR parameter associated with the first subset of uplink power control parameters and of a transmission configuration indicator (TCI) state for a first transmission in one or more SBFD symbols, and
wherein the non-SBFD PHR parameter includes a second type-1 PHR parameter associated with the second subset of uplink power control parameters and of the TCI state.

9. The UE of claim 1, wherein the SBFD PHR parameter includes a first type-1 PHR parameter associated with an SBFD transmission configuration indicator (TCI) state and for a first transmission in one or more SBFD symbols using a spatial domain filter, and includes an SBFD-specific uplink power control parameter of the SBFD TCI state, and
wherein the non-SBFD PHR parameter includes a second type-1 PHR parameter associated with a non-SBFD TCI state for a second transmission in one or more non-SBFD symbols using the spatial domain filter, and includes a non-SBFD-specific uplink power control parameter of the non-SBFD TCI state.

10. The UE of claim 1, wherein the set of PHR parameters is based on at least one of:
a first physical uplink shared channel (PUSCH) transmission in a slot,
a PUSCH transmission associated with a first uplink power control parameter in a transmission configuration indicator state,
a PUSCH transmission associated with a first TCI state, or
a PUSCH transmission associated with a first symbol type of a slot in which the set of PHR parameters is reported.

11. The UE of claim 1, wherein the set of PHR parameters is based on at least one of:
a first reference physical uplink shared channel (PUSCH) transmission in a slot,
a reference PUSCH transmission associated with a first uplink power control parameter in a transmission configuration indicator state,
a reference PUSCH transmission associated with a first TCI state,
a reference PUSCH transmission associated with a first symbol type of a slot in which the set of PHR parameters is reported,
a reference PUSCH transmission associated with an SBFD symbol uplink power control parameter, or
a reference PUSCH associated with an SBFD TCI state.

12. The UE of claim 1, wherein the information identifying the set of PHR parameters is a single entry PHR parameter for a single transmit receive point SBFD.

13. The UE of claim 1, wherein the set of PHR parameters includes one or more PHR parameters for a first waveform and one or more PHR parameters for a second waveform.

14. The UE of claim 1, wherein a quantity of PHR parameters in the set of PHR parameters is based on a UE capability indication.

15. A network node, comprising:
a processing system that includes processor circuitry and code-storing memory circuitry, the processing system configured to cause the network node to:
transmit configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation; and
receive information identifying a set of power headroom (PHR) parameters for a serving cell, wherein the set of PHR parameters includes an SBFD PHR parameter and a non-SBFD PHR parameter for the serving cell.

16. The network node of claim 15, wherein the processing system, to cause the network node to transmit the configuration information, is configured to cause the network node to transmit information identifying at least one of:
an SBFD resource configuration parameter,
a PHR mode parameter,
a plurality of sounding reference signal (SRS) resource set parameters, or
a transmission configuration indicator (TCI) state configured with SBFD-specific and non-SBFD specific power parameters.

17. The network node of claim 16, wherein whether a PHR report includes a single PHR parameter or two PHR parameters based on a configuration of the set of uplink power control parameters.

18. The network node of claim 15, wherein a PHR parameter is based on at least one of:
a physical uplink shared channel (PUSCH) transmission,
a sounding reference signal (SRS) transmission,
a reference PUSCH transmission, or
a reference SRS transmission.

19. The network node of claim 15, wherein, within a reporting message, the SBFD PHR parameter is before the non-SBFD PHR parameter.

20. The network node of claim 15, wherein, within a reporting message, a bit indicator identifies whether a PHR parameter is the SBFD PHR parameter or is the non-SBFD PHR parameter.

21. The network node of claim 15, wherein the SBFD PHR parameter is a first PHR parameter based on a transmission in one or more SBFD symbols or is associated with an SBFD transmission configuration indicator (TCI) state, and
wherein the non-SBFD PHR parameter is a second PHR parameter based on a transmission in one or more non-SBFD symbols or is associated with a non-SBFD TCI state.

22. The network node of claim 15, wherein the SBFD PHR parameter includes a first type-1 PHR parameter associated with a first subset of uplink power control parameters of a transmission configuration indicator (TCI) state for a first transmission in one or more SBFD symbols, and
wherein the non-SBFD PHR parameter includes a second type-1 PHR parameter associated with a second subset of uplink power control parameters of the TCI state.

23. The network node of claim 15, wherein the SBFD PHR parameter includes a first type-1 PHR parameter associated with an SBFD transmission configuration indicator (TCI) state and for a first transmission in one or more SBFD symbols using a spatial domain filter, and includes an SBFD-specific uplink power control parameter of the SBFD TCI state, and
wherein the non-SBFD PHR parameter includes a second type-1 PHR parameter associated with a non-SBFD TCI state for a second transmission in one or more non-SBFD symbols using the spatial domain filter, and includes a non-SBFD-specific uplink power control parameter of the non-SBFD TCI state.

24. The network node of claim 15, wherein the set of PHR parameters is based on at least one of:
a first physical uplink shared channel (PUSCH) transmission in a slot,
a PUSCH transmission associated with a first uplink power control parameter in a transmission configuration indicator state,
a PUSCH transmission associated with a first TCI state, or
a PUSCH transmission associated with a first symbol type of a slot in which the set of PHR parameters is reported.

25. The network node of claim 15, wherein the set of PHR parameters is based on at least one of:
a first reference physical uplink shared channel (PUSCH) transmission in a slot,
a reference PUSCH transmission associated with a first uplink power control parameter in a transmission configuration indicator state,
a reference PUSCH transmission associated with a first TCI state,
a reference PUSCH transmission associated with a first symbol type of a slot in which the set of PHR parameters is reported,
a reference PUSCH transmission associated with an SBFD symbol uplink power control parameter, or
a reference PUSCH associated with an SBFD TCI state.

26. The network node of claim 15, wherein the information identifying the set of PHR parameters is a single entry PHR parameter for a single transmit receive point SBFD.

27. The network node of claim 15, wherein the set of PHR parameters includes one or more PHR parameters for a first waveform and one or more PHR parameters for a second waveform.

28. The network node of claim 15, wherein a quantity of PHR parameters in the set of PHR parameters is based on a UE capability indication.

29. A method of wireless communication performed by a user equipment (UE), comprising:
receiving configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation; and
transmitting information identifying a set of power headroom (PHR) parameters for a serving cell, wherein the set of PHR parameters includes an SBFD PHR parameter and a non-SBFD PHR parameter for the serving cell.

30. A method of wireless communication performed by a network node, comprising:
transmitting configuration information identifying a set of uplink power control parameters, wherein the set of uplink power control parameters includes a first subset of uplink power control parameters for uplink transmission in sub-band full-duplex (SBFD) operation and a second subset of uplink power control parameters for uplink transmission in half-duplex operation; and
receiving information identifying a set of power headroom (PHR) parameters for a serving cell, wherein the set of PHR parameters includes an SBFD PHR parameter and a non-SBFD PHR parameter for the serving cell.
